(19) United States
(12) Patent Application Publication
(10) Pub. No.: US 2025/0173945 A1
(43) Pub. Date: May 29, 2025

(54) DISPLAY ELEMENT RENDERING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Xining ZHUO, Shenzhen (CN); Yingfeng LIAO, Shenzhen (CN); Guang BAI, Shenzhen (CN); Wenqing ZHANG, Shenzhen (CN); Jiafeng HAN, Shenzhen (CN)

(21) Appl. No.: 19/030,882

(22) Filed: Jan. 17, 2025

Related U.S. Application Data
(63) Continuation of application No. PCT/CN2023/130375, filed on Nov. 8, 2023.

(30) Foreign Application Priority Data
Feb. 8, 2023 (CN) 202310152279.4

(51) Int. Cl. G06T 15/00

(52) U.S. Cl. CPC G06T 15/00

(57) ABSTRACT

Disclosed is a display element rendering method performed by a computer device. The method includes: determining world vertex coordinates of the display element in a world space, the display element being an element displayed at an unchanged position on a screen; determining a world position offset of the display element based on an offset mode of the world vertex coordinates in a view transformation process; performing coordinate space transformation based on the world vertex coordinates and the world position offset to obtain screen vertex coordinates of the display element in a screen space; and rendering the display element based on the screen vertex coordinates.

### CROSS-REFERENCE TO RELATED APPLICATIONS

This application is a continuation application of PCT Patent Application No. PCT/CN2023/130375, entitled “DISPLAY ELEMENT RENDERING METHOD AND APPARATUS, DEVICE, STORAGE MEDIUM, AND PROGRAM PRODUCT” filed on Nov. 8, 2023, which claims priority to Chinese Patent Application No. 202310152279.4, entitled “DISPLAY ELEMENT RENDERING METHOD AND APPARATUS, DEVICE, STORAGE MEDIUM, AND PROGRAM PRODUCT” filed on Feb. 8, 2023, both of which are incorporated by reference in their entirety.

### FIELD OF THE TECHNOLOGY

Embodiments of this application relate to the field of computer technologies, and in particular, to a display element rendering method and apparatus, a device, a storage medium, and a program product.

### BACKGROUND OF THE DISCLOSURE

In a rendering process of a display picture, there may be some special display elements, such as particle effects, that need to be always displayed on a screen.

In the related art, to continuously display a particular display element on a screen, off-screen rendering is usually adopted for rendering. In this process, a display element is photographed by using a 2D camera, a photographing result is stored, and a stored photographing picture is rendered onto the screen subsequently.

It can be seen that the off-screen rendering mode needs to occupy an additional storage space, and has relatively low efficiency.

### SUMMARY

Embodiments of this application provide a display element rendering method and apparatus, a device, a storage medium, and a program product. No additional storage space needs to be occupied, which is helpful to improve rendering efficiency. Technical solutions are as follows:

According to an aspect, embodiments of this application provide a method for rendering a display element performed by a computer device. The method includes:
determining world vertex coordinates of the display element in a world space, where the display element is an element displayed at an unchanged position on a screen;
determining a world position offset of the display element based on an offset mode of the world vertex coordinates in a view transformation process;
performing coordinate space transformation based on the world vertex coordinates and the world position offset to obtain screen vertex coordinates of the display element in a screen space; and
rendering the display element based on the screen vertex coordinates.

According to another aspect, embodiments of this application provide a computer device. The computer device includes a processor and a memory. The memory has at least one computer instruction stored therein. The at least one computer instruction is loaded and executed by the processor to implement the display element rendering method as described in the foregoing aspect.

According to another aspect, a non-transitory computer-readable storage medium is provided. The non-transitory computer-readable storage medium has at least one computer instruction stored therein. The at least one computer instruction is loaded and executed by a processor to implement the display element rendering method as described in the foregoing aspect.

In embodiments of this application, in a view transformation process, a computer device may determine a world position offset of a display element according to an offset of a world space caused by view transformation. Thus, in a coordinate transformation process, the world position offset is introduced to cancel a position offset caused by the view transformation, so that screen vertex coordinates obtained after coordinate transformation remain unchanged, it is ensured that a display position of the display element on a screen remains unchanged, and a dynamic effect that the display element is moved with the view transformation is achieved. In this process, no additional module or plug-in needs to be used, and no additional storage space needs to be occupied to store an off-screen rendering result. Continuous display of the display element is maintained in a mode of calculating the world position offset in real time, which is helpful to improve rendering efficiency.

### BRIEF DESCRIPTION OF THE DRAWINGS

FIG. 1 shows a flowchart of a display element rendering method according to an exemplary embodiment of this application.

FIG. 2 shows a schematic diagram of a display position of a display element in a view transformation process according to an exemplary embodiment of this application.

FIG. 3 shows a flowchart of a rendering pipeline according to an exemplary embodiment of this application.

FIG. 4 shows a flowchart of a coordinate transformation process according to an exemplary embodiment of this application.

FIG. 5 shows a flowchart of a display element rendering method according to another exemplary embodiment of this application.

FIG. 6 shows a schematic diagram of an attribute setting interface of a world position offset according to an exemplary embodiment of this application.

FIG. 7 shows a schematic diagram of a preview interface of a display element according to an exemplary embodiment of this application.

FIG. 8 shows a schematic diagram of a depth test disabling interface according to an exemplary embodiment of this application.

FIG. 9 shows a schematic diagram of a particle facing setting interface according to an exemplary embodiment of this application.

FIG. 10 shows a structural block diagram of a display element rendering apparatus according to an exemplary embodiment of this application.

FIG. 11 shows a structural block diagram of a computer device according to an exemplary embodiment of this application.

### DESCRIPTION OF EMBODIMENTS

To make the objectives, technical solutions, and advantages of this application clearer, the following further describes implementations of this application in detail with reference to the accompanying drawings.

“A plurality of” mentioned herein means two or more. “And/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects.

In some special rendering requirements, a display element may need to be rendered on a fixed position of a screen. To be specific, the display element is rendered on the screen as a user interface (UI) component. In the related art, a virtual engine is built with an Unreal Motion Graphic component configured to render a UI element. However, in this mode, a dynamic effect cannot be achieved. To be specific, the display element cannot be continuously displayed at the fixed position on the screen. In another mode, rendering of some screen effects may be implemented in a post-processing mode, but the foregoing dynamic effect also cannot be achieved.

Furthermore, rendering may be performed in an off-screen rendering mode. In this mode, a display element is photographed by using a SceneCapture2D camera, a photographing result is written into a Render Target in real time, and then the Render Target is rendered onto the screen. This mode needs to occupy an additional storage space to store an off-screen rendering result.

Embodiments of this application provide a display element rendering method. A world position offset is introduced. In a coordinate transformation process, a relative offset in a world space caused by view transformation may be canceled based on the world position offset. Thus, the display element may be rendered at a fixed position on a screen, thereby achieving a dynamic effect that the display element may move with the view transformation. In this process, no additional module or plug-in needs to be cited, no post-processing method needs to be used, and no additional internal memory needs to be occupied. Only when a world coordinate offset of a material of the display element needs to be changed by deduction, the display element, as a UI, may be rendered onto the screen. The solution is highly implementable, and may be widely applied to a display element rendering process, thereby expanding the diversity and possibility of element rendering.

The method provided in embodiments of this application may be applied to a rendering process of any display element that needs to be fixedly displayed on a screen. Exemplarily, the method may be applied to a particle rendering process. When a particle effect (for example, a firework) needs to be fixedly displayed on the screen, in the rendering process, a world position offset may be determined according to a world offset caused by view transformation, and then world space coordinates of a particle vertex are updated based on the world position offset to cancel an offset caused by the view transformation, so that the particle effect is rendered at a fixed position on the screen. Certainly, the method provided in embodiments of this application may further be applied to a rendering scenario of another element. This is not limited in this embodiment.

The method provided in embodiments of this application may be applied to a computer device. The computer device is a device having an image rendering function. The device may be a terminal such as a smartphone, a tablet computer, or a personal computer, or may be a background server configured to provide a graphic rendering service. This is not limited in this embodiment. Descriptions are provided below by using an exemplary embodiment.

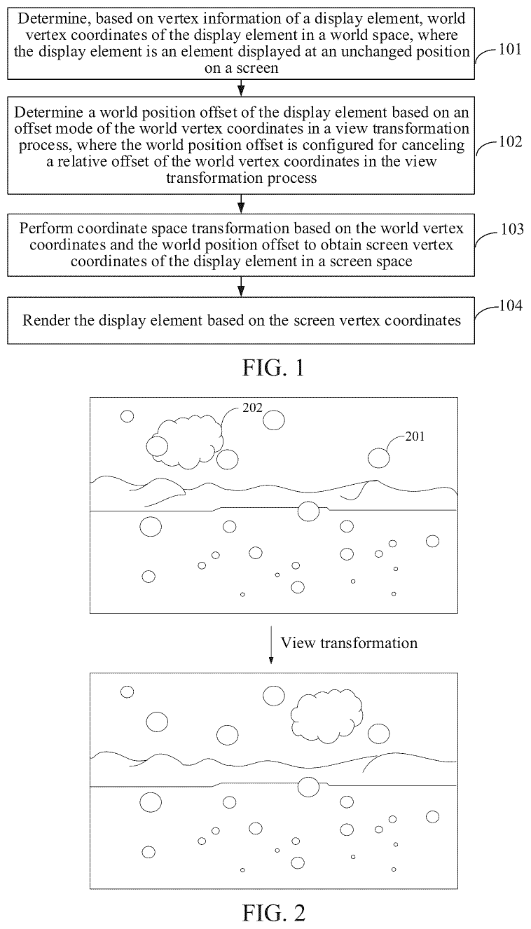

FIG. 1 shows a flowchart of a display element rendering method according to an exemplary embodiment of this application. This embodiment is described by using an example in which the method is used in a computer device. The method includes the following operations.

Operation 101: Determine, based on vertex information of a display element, world vertex coordinates of the display element in a world space, where the display element is an element displayed at an unchanged position on a screen.

In embodiments of this application, the display element refers to an element display at an unchanged position on the screen. To be specific, in the process of view transformation, the display element is always displayed at a fixed position on the screen. For example, the display element may be a particle effect, a virtual character, or a virtual object (for example, a shield attached to a virtual character wearing a mask or a helmet under a first-person view). This is not limited in this embodiment.

In some embodiments, the display position of the display element on the screen may be adjusted by a user in advance, and rendering is performed according to a fixed position set by the user in a rendering process. Alternatively, the display position of the display element on the screen is a preset position.

The vertex information is information about a vertex of a basic graph forming the display element. In some embodiments, the vertex information includes vertex coordinates of each vertex. The vertex coordinates in the vertex information are coordinate information in a local space (i.e. a model space). To be specific, the vertex coordinates are coordinates using a model center as an origin, and the model center is set during modeling. In the rendering process, first, transformation to the world space needs to be performed to obtain world vertex coordinates corresponding to the display element. The world vertex coordinates are coordinates of the vertex of the display element in the world space.

In a possible implementation, the computer device may perform homogenization on a three-dimensional vector (three-dimensional coordinates corresponding to the vertex) corresponding to the vertex in the local space, and then pre-multiply a model matrix to obtain homogeneous coordinates in the world space, i.e. the world vertex coordinates. The model matrix is configured for performing space transformation from a model space to a world space. The world space may be a virtual world space.

Operation 102: Determine a world position offset of the display element based on an offset mode of the world vertex coordinates in a view transformation process, where the world position offset is configured for canceling a relative offset of the world vertex coordinates in the view transformation process.

The view transformation refers to a process in which an angle of observing a virtual world changes. For example, when a virtual object in the virtual world moves, turns, raises head, or lowers head, a view of the virtual object is transformed.

Usually, the view transformation enables a picture displayed on the screen to be transformed. In this process, an object in the world space is usually offset. To be specific, in the view transformation process, world vertex coordinates are offset to some extent. For example, when the view is switched from left to right, an object displayed on the left side in the original screen is gradually no longer displayed.

To enable the display element to be displayed at a fixed position on the screen all the time, in embodiments of this application, a world position offset is introduced, and a relative offset of the display element in the view transformation process is canceled by using the world position offset, so that a display position of the display element on the screen remains unchanged.

In a possible implementation, in the view transformation process (i.e. in a camera moving process), an offset mode of the world vertex coordinates is related to a position of the camera, and the computer device may determine an offset of the world vertex coordinates according to the position of the camera in the view transformation process, to determine the world position offset of the display element according to the offset of the world vertex coordinates.

In some embodiments, the view transformation is view translation transformation. For example, the view moves from left to right, moves from top to down, or moves from top left to bottom right. Alternatively, the view transformation may be view rotation transformation. For example, the view changes from being towards north to being towards east. This is not limited in this embodiment.

Operation 103: Perform coordinate space transformation based on the world vertex coordinates and the world position offset to obtain screen vertex coordinates of the display element in a screen space.

In some embodiments, after the world position offset corresponding to the display element is obtained, coordinate update may be first performed on the world vertex coordinates based on the world position offset, and then space transformation is performed based on the updated world vertex coordinates to obtain screen vertex coordinates of the display element in the screen space. The screen vertex coordinates are coordinates of the vertex of the display element in the screen space.

Operation 104: Render the display element based on the screen vertex coordinates.

After obtaining the screen vertex coordinates, the computer device may input the screen vertex coordinates into a rasterizer to perform rasterization calculation, gradually perform pixel shading calculation and test and mixing processes, output the display element obtained by rendering to a frame buffer, and finally read rendering data from the frame buffer for screen display.

The rasterization calculation is configured for determining a pixel drawn on the screen in a rendered primitive. Calculation may be performed according to vertex data obtained in a previous stage to complete transformation from a point in a two-dimensional screen space to a pixel point on the screen. The pixel shading calculation is mainly to process shading calculation of each pixel by using interpolation.

Since the world position offset is used for eliminating an offset caused by view transformation, the display position of the display element on the screen remains unchanged. Schematically, as shown in FIG. 2, when a view moves, a display position of a display element 201 on a screen remains unchanged, and only a virtual scene 202 is correspondingly changed according to switching of the view.

To be specific, compared with the mode in the related art, the mode provided in embodiments of this application can achieve a dynamic effect that the display element is moved according to a view, and compared with an off-screen rendering mode, the mode provided in embodiments of this application can save an additional storage space, so that the display position of the display element on the screen can be kept unchanged only by calculating a world position offset, and the rendering diversity and possibility of display element can be expanded.

By reason of the foregoing, in embodiments of this application, in a view transformation process, a computer device may determine a world position offset of a display element according to an offset of a world space caused by view transformation. Thus, in a coordinate transformation process, the world position offset is introduced to cancel a position offset caused by the view transformation, so that screen vertex coordinates obtained after coordinate transformation remain unchanged, it is ensured that a display position of the display element on a screen remains unchanged, and a dynamic effect that the display element is moved with the view transformation is achieved. In this process, no additional module or plug-in needs to be used, and no additional storage space needs to be occupied to store an off-screen rendering result. Continuous display of the display element is maintained in a mode of calculating the world position offset in real time, which is helpful to improve rendering efficiency.

The world position offset is related to an offset of world vertex coordinates in the view transformation process. A calculation principle of the world position offset is described below.

Vertex information of a display element is transmitted by a central processing unit (CPU) to a graphics processing unit (GPU) through a graphics interface, and a rendering pipeline in the GPU performs rendering and drawing according to the vertex information, performs calculation and output to a frame buffer (screen buffer), and finally displays a rendered picture on a screen.

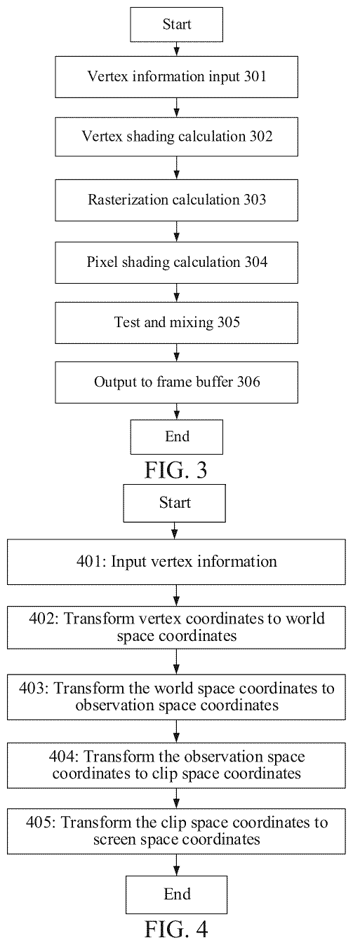

A rendering process related to the entire rendering pipeline is shown in FIG. 3. After vertex information 301 is inputted, a vertex shader performs vertex shading calculation 302, inputs the vertex information to a rasterizer for rasterization calculation 303, and then inputs the vertex information to a pixel shader for pixel shading calculation 304. After the shading calculation, test and mixing are performed 305 to complete rendering calculation, and rendering data obtained by calculation is outputted to a frame buffer 306 to obtain a final rendered picture.

The vertex shading calculation mainly changes coordinates. In this process, the computer device first transforms vertex coordinates of a model from a model space to a world space, then transforms from the world space to an observation space (also referred to as a camera space), then transforms from the observation space to a clip space, and transforms from the clip space to a screen space to obtain a final output result. As shown in FIG. 4, the coordinate transformation process includes the following operations.

Operation 401: Input vertex information.

Operation 402: Transform vertex coordinates to world space coordinates.

Operation 403: Transform the world space coordinates to observation space coordinates.

Operation 404: Transform the observation space coordinates to clip space coordinates.

Operation 405: Transform the clip space coordinates to screen space coordinates.

The coordinate transformation process is implemented through matrix multiplication. In this process, vertex coordinates may be pre-multiplied by a model matrix to obtain coordinates in the world space, and then pre-multiplied by a vision matrix to obtain coordinates in the observation space. Then, the vertex coordinates are pre-multiplied by a clip matrix to obtain clip space coordinates, and final screen space coordinates are coordinates in a clip space coordinate system. The vision matrix may further be referred to as an observation matrix of a camera. The clip matrix may further be referred to as a projection matrix. Correspondingly, the clip space coordinates may be referred to as projection coordinates.

Schematically, when the vertex coordinates in the model space are A, the model matrix is M, the vision matrix of a scene camera is V, and the projection matrix is P, the process of coordinate transformation from the model space to the world space may be as follows:

$${A}^{′} = P \times V \times M \times A$$

When the display element needs to be rendered to a fixed position on the screen, coordinate transformation of the vertex needs to be fixed as follows:

$${A}^{″} = P \times {V}^{′} \times M \times A$$

where V′ is a vision matrix of a UI camera. The UI camera is a fixed camera located at an origin of the world space, and the UI camera is configured to photograph a display element, and fix a rendering position of the display element on a screen by transforming the display element into an observation space corresponding to the UI camera.

In the foregoing formula, V is a vision matrix of a scene camera, where the scene camera is a camera that photographs an entire scene by default, i.e. a camera corresponding to an observation view of an observer, and a position of the camera moves with view transformation. The coordinate transformation process in a virtual engine is encapsulated, and cannot be directly modified. Therefore, world space coordinates are changed by introducing a world position offset, so that A′ is equal to A″, and a fixed rendering effect is achieved. A process of changing final world space coordinates by using the world position offset may be expressed as:

$${A}^{′} = P \times V \times ( M \times A + WPO )$$

where WPO represents the world position offset.

To keep the display position of the display element on the screen unchanged, A′=A″, as shown in the following formula:

$$P \times V \times ( M \times A + WPO ) = P \times {V}^{′} \times M \times A$$

Thus, the world position offset may be:

$$WPO = {V}^{-} \times {V}^{′} \times M \times A - M \times A$$

where V⁻ is an inverse vision matrix of the scene camera, i.e. an inverse matrix of the vision matrix corresponding to the scene camera.

It can be seen that the world position offset is related to the inverse vision matrix of the scene camera, the vision matrix of the UI camera, and the world vertex coordinates of the display element. The following exemplarily describes modes of calculating a world position offset and performing space transform based on the world position offset in a rendering process.

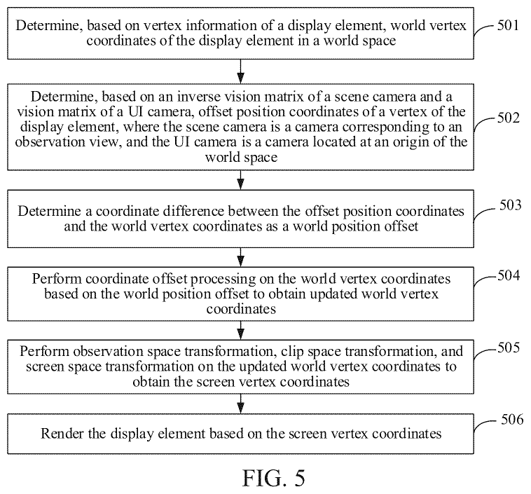

FIG. 5 shows a flowchart of a display element rendering method according to another exemplary embodiment of this application. This embodiment is described by using an example in which the method is used in a computer device. The method includes the following operations.

Operation 501: Determine, based on vertex information of a display element, world vertex coordinates of the display element in a world space.

For an implementation of this operation, refer to operation 101 in the foregoing embodiments. Details are not described in this embodiment again.

Operation 502: Determine, based on an inverse vision matrix of a scene camera and a vision matrix of a UI camera, offset position coordinates of a vertex of the display element, where the scene camera is a camera corresponding to an observation view, and the UI camera is a camera located at an origin of the world space.

To fix the display position of the display element in the view transformation process, the computer device may transform the world vertex coordinates according to the inverse vision matrix of the scene camera and the vision matrix of the UI camera to obtain offset position coordinates of the vertex of the display element in the view transformation process.

The offset position coordinates are coordinates that are obtained after a position of the vertex of the display element is offset in the observation space.

In some embodiments, the process of determining the offset position coordinates includes the following operations.

Operation 502a: Transform the world vertex coordinates based on the vision matrix of the UI camera to obtain UI observation coordinates.

First, the computer device transforms the world vertex coordinates by using the vision matrix of the UI camera. An initial view of the UI camera created at an origin of the world space is upward. To adapt to an observation view of a user, coordinate axes need to be sequentially adjusted. To be specific, the view of the UI camera is adjusted. According to adjustment on the coordinate axes, the vision matrix of the UI camera may be shown as follows:

$${V}^{′} = [ \begin{matrix}0 & 1 & 0 & 0 \\ 0 & 0 & 1 & 0 \\ 1 & 0 & 0 & 0 \\ 0 & 0 & 0 & 1\end{matrix} ]$$

To be specific, a transformation mode of the vision matrix of the UI camera is coordinate axis transformation. The transformation of V′ is equivalent to transforming an X axis to a Z axis, transforming a Y axis to the X axis, and transforming the Z axis to the X axis.

The computer device performs coordinate axis transformation on the world vertex coordinates to obtain the UI observation coordinates.

Operation 502b: Transform the UI observation coordinates based on the inverse vision matrix of the scene camera to obtain the offset position coordinates.

After obtaining the UI observation coordinates, the computer device then transforms the UI observation coordinates based on the inverse vision matrix of the scene camera (i.e. pre-multiplying the UI observation coordinates by the inverse vision matrix), to determine a position offset of the vertex of the display element caused by the view transformation.

The vision matrix of the scene camera is configured for transforming the world space coordinates to the observation space coordinates in the observation space corresponding to the scene camera. The inverse vision matrix is configured for transforming the observation space coordinates into the world space coordinates. To be specific, a transformation mode of the inverse vision matrix corresponds to a transformation mode from the observation space corresponding to the scene camera to the world space. Therefore, the computer device may transform the UI observation coordinates in a mode of transforming the observation space coordinates into the world space coordinates, to obtain an offset position.

In a possible implementation, the computer device transforms the UI observation coordinates based on a transformation mode from an observation space to the world space to obtain the offset position coordinates.

As shown in the following formula, the offset position coordinates are:

$${V}^{-} \times {V}^{′} \times M \times A$$

Operation 503: Determine a coordinate difference between the offset position coordinates and the world vertex coordinates as a world position offset.

After determining the offset position, the computer device may subtract the world vertex coordinates from the offset position coordinates, to obtain the world position offset, i.e. V⁻×V′×M×A−M×A, where the world vertex coordinates are M×A.

The process of calculating the world position offset and the foregoing process of transforming the vertex coordinates in the model space into the vertex coordinates in the world space may be synchronously performed or may be sequentially performed. This embodiment merely exemplarily describes an implementation, and does not limit an execution time sequence.

Operation 504: Perform coordinate offset processing on the world vertex coordinates based on the world position offset to obtain updated world vertex coordinates.

After the world position offset is determined, the computer device may update the world vertex coordinates obtained after the world space transformation. To be specific, the world position offset and the world vertex coordinates are added to eliminate a coordinate offset caused by vision transformation, thereby obtaining updated world vertex coordinates. The process of coordinate offset processing may be represented as M×A+WPO.

Operation 505: Perform observation space transformation, clip space transformation, and screen space transformation on the updated world vertex coordinates to obtain the screen vertex coordinates.

Then, the computer device may sequentially perform observation space transformation, clip space transformation, and screen space transformation on the updated world vertex coordinates to obtain the screen vertex coordinates.

In a possible implementation, the computer device performs observation space transformation on updated world vertex coordinates by using an observation matrix (i.e. a vision matrix of a scene camera) to obtain observation vertex coordinates, transforms the observation vertex coordinates by using a projection matrix (i.e. a clip matrix) to obtain clip vertex coordinates, and then performs a series of processing such as clipping to complete screen space transformation to obtain screen vertex coordinates.

Operation 506: Render the display element based on the screen vertex coordinates.

For an implementation of this operation, refer to the foregoing operation 104. Details are not described in this embodiment again.

In this embodiment, the offset position of the vertex of the display element in the view transformation process is determined based on the inverse vision matrix corresponding to the scene camera and the vision matrix of the UI camera, to determine the world position offset of the vertex of the display element. The offset of the world space is canceled by the world position offset, so that the display element may be fixedly rendered on the screen as the UI, thereby expanding rendering diversity of the display element.

In the foregoing embodiments, the world vertex coordinates are adjusted by introducing the world position offset, so that a fixed rendering position of the display element on the screen is implemented. The world position offset needs to be introduced by modifying material information of the display element.

The material information is information that is set in advance by the user using a material editor in a virtual engine. The material information includes a world position offset attribute. The world position offset attribute may be set, so that in a rendering process, a world position offset may be calculated according to an indication of the world position offset attribute, and the world vertex coordinates are offset.

In some embodiments, a process of editing the world position offset attribute may be performed by the user, or may be automatically performed by the computer device. This is not limited in this embodiment.

The world position offset is related to the world vertex coordinates of the display element, the inverse vision matrix of the scene camera, and the vision matrix of the UI camera. The world vertex coordinates, the inverse vision matrix of the scene camera, and the vision matrix of the UI camera may be introduced by using a node in the material editor.

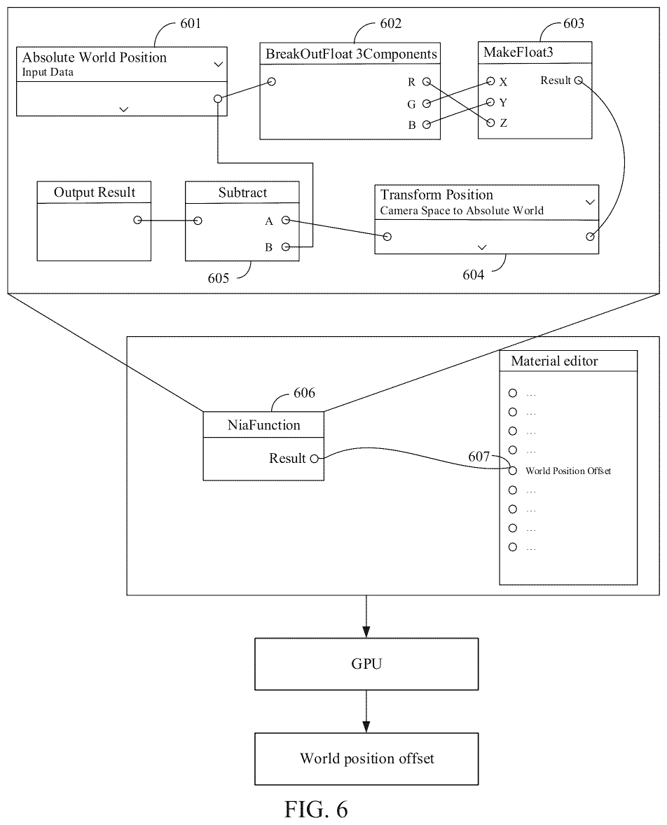

In some embodiments, the world vertex coordinates are provided by an absolute world position node in the material editor of the virtual engine, or the world vertex coordinates may be provided by an excluding material offsets node. An Absolute World Position node 601 is used as an example for description in FIG. 6.

The vision matrix of the UI camera actually is coordinate axis transformation. The coordinate axis transformation may be implemented by editing a vector splitting node and a vector splicing node in the material editor. In some embodiments, the vector splitting node may be a BreakOutFloat3Components node (configured to split a vector into single-channel scalars, for example, super-split into RGB channels), and the vector splicing node may be a MakeFloat3 node (configured to combine single-channel scalars into a vector, for example, combine X, Y, and Z channels). The coordinate axis transformation is implemented through connection of nodes.

Schematically, as shown in FIG. 6, a connection mode between nodes may be: connecting an R node in a BreakOutFloat3Components node 602 to a Z node in a MakeFloat3 node 603, to implement X-axis to Z-axis transformation; connecting a G node in the BreakOutFloat3Components node 602 to an X node in the MakeFloat3 node 603, to implement X-axis to Z-axis transformation; and connecting a B node in the BreakOutFloat3Components node 602 to a Y node in the MakeFloat3 node 603, to implement X-axis to Z-axis transformation.

The material editor of the virtual engine cannot obtain the vision matrix of the scene camera and calculate inversion. Therefore, transformation corresponding to the inverse vision matrix may be implemented by using a coordinate transformation node Transform Position. Observation space coordinates in the observation space may be obtained by pre-multiplying coordinates in the world space by the vision matrix. To be specific,

$${x}_{V} = V {x}_{M}$$

the following may be obtained by multiplying both sides of the equation by inverse matrices:

$${V}^{-} {x}_{V} = {x}_{M}$$

It can be seen that transforming the observation space coordinates back to the world space coordinates is pre-multiplying an inverse matrix V⁻ by V to obtain the inverse matrix V⁻ pre-multiplied by V. As shown by a Transform Position node 604 in FIG. 6, the node is configured for implementing coordinate transformation from the camera observation space to the world space (Camera Space to Absolute World).

After nodes are introduced, a connection between the nodes may be encapsulated to obtain an element offset function node corresponding to an element offset function. The element offset function is configured for indicating a calculation mode of the world position offset. After the element offset function node is obtained, a world position offset attribute is set based on the element offset function node, so that in a subsequent rendering process, the world position offset may be calculated according to the element offset function indicated by the world position offset attribute. To be specific, the operation of calculating the world position offset in the foregoing embodiments is performed.

In a possible implementation, encapsulation is performed to obtain an element offset function node in response to a connection operation on the absolute world position node, the edited vector splitting node, the edited vector splicing node, and the edited coordinate transformation node. The element offset function node is configured for invoking an element offset function, and the element offset function is configured for calculating the world position offset.

To be specific, the user may edit to obtain the element offset function node by using a connection operation on the foregoing nodes. Schematically, as shown in FIG. 6, the Absolute World Position node 601 (inputted as world vertex coordinates) is connected to a node formed by the BreakOutFloat3Components node 602 and the MakeFloat3 node 603 for coordinate axis transformation to perform pre-multiplication on the world vertex coordinates by the vision matrix of the UI camera. An output result is connected to the Transform Position node 604 (transformation from the observation space of the camera to the world space) to perform pre-multiplication by the inverse vision matrix of the scene camera. The output result is connected to node A in a Subtract node 605, and the Absolute World Position node 601 is connected to node B of the Subtract node 605 to calculate a difference between coordinates pre-multiplied by the inverse vision matrix and the world vertex coordinates, thereby obtaining an output result.

The computer device may perform encapsulation according to the connection operation to obtain the element offset function node. Certainly, the foregoing node connection operation may alternatively be automatically performed by the computer device. This is not limited in this embodiment.

After the element offset function node is obtained through encapsulation, the element offset function node is connected to a world position offset node in the material editor to complete setting of the world position offset attribute. Moreover, the encapsulated element offset function node may be stored, so as to be invoked during subsequent rendering of another display element.

In a possible implementation, in response to a connection operation on the element offset function node and the world position offset node, a world position offset attribute is added to the display element. The world position offset attribute is configured for indicating the element offset function.

In some embodiments, the world position offset attribute may be set by a user. When the user needs to fixedly render a current display element at a particular position on a screen, the user may connect the element offset function node to the world position offset node in the material editor. When receiving a connection operation on the element offset function node and the world position offset node, the computer device may add the world position offset attribute to the display element.

In another possible implementation, the element offset function node is connected to the world position offset node in response to an element fixing display instruction, and a world position offset attribute is added to the display element. The element fixing display instruction is configured for instructing to fix a display position of the display element on the screen.

In some embodiments, setting the world position offset attribute may be automatically performed by the computer device. An operation control configured to trigger and instruct the display element to be fixedly displayed on the screen may be set in the material editor. The user may trigger an element fixing display instruction by a trigger operation on the operation control. After receiving the element fixing display instruction, the computer device may connect the encapsulated element offset function node to the world position offset node, to add the world position offset attribute to the display element, which is helpful to simplify a setting operation of the user.

Alternatively, the user may preset an element type of a display element to be fixedly rendered. When the corresponding element type is detected, the computer device automatically introduces the element offset function node to the world offset function node in the material editor, without the need of performing setting by the user.

Schematically, as shown in FIG. 6, an element offset function node 606 (NiaFunction) may be obtained by encapsulation. When the element offset function node 606 is connected to a world position offset node 607 in the material editor, a world position offset attribute may be added to the display element.

The world position offset attribute belongs to material information of the display element. The CPU further transmits the material information of the display element to the GPU through the graphical interface. After receiving the material information, the GPU may calculate the world position offset according to the element offset function corresponding to the world position offset attribute, to change the world space coordinates in the coordinate transformation process based on the world position offset, thereby implementing fixed rendering of the display element.

Schematically, as shown in FIG. 6, after setting of the material information (including the world position offset attribute) is completed, the material information is transmitted to the GPU, and the GPU may obtain the corresponding element offset function, to calculate the world position offset of each vertex based on the element offset function, for use in a subsequent coordinate transformation process.

In this embodiment, the process of obtaining the element offset function node through encapsulation and connecting the element offset function node to the world position offset node in the material editor assigns the world position offset attribute to the material of the display element, so that in the rendering process, the world position offset may be calculated according to the element offset function corresponding to the world position offset attribute, thereby changing the world position offset, and implementing fixed rendering.

Moreover, in this embodiment, the world position offset attribute of the element material may further be automatically set according to the element fixing display instruction of the user, thereby simplifying a user operation and improving efficiency.

In the foregoing embodiments, a process of presetting the world position offset attribute of the material corresponding to the display element is described. Before the element material is modified, the display position of the display element may be adjusted, so that the display position of the display element satisfies a user requirement. The process may include the following operations.

Operation 1: Create a UI camera at an origin of coordinates in the world space in response to a camera creation instruction, where the UI camera is configured to photograph the display element.

In a possible implementation, the user may create a virtual camera in a scene, to preview a display effect of the display element, for subsequent adjustment. When receiving a camera creation instruction, the computer device may create a UI camera in the scene, to photograph the display element. In addition, after the UI camera is created, a rotation change of the UI camera further needs to be reset. To be specific, the UI camera is set at a coordinate origin of the world space, to avoid impact on a subsequent world position offset.

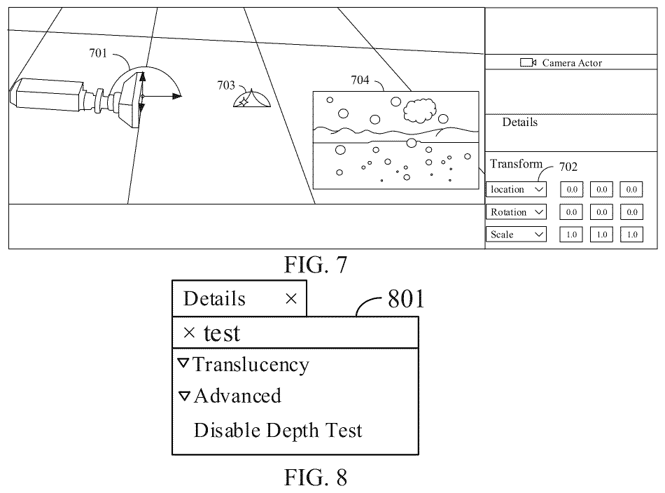

Schematically, as shown in FIG. 7, a UI camera 701 is created in a scene, and a rotation change 702 (including location, rotation, and scale) of the UI camera is reset, so that the UI camera is located at an origin of world coordinates in the world space.

Operation 2: Present, when the UI camera photographs the display element within a scene, an element display position of the display element on the screen in a photographing picture of the UI camera.

The user may place the display element in the scene. In a case that the UI camera photographs the display element in the scene, an element display position may be presented in a photographing picture of the UI camera, so that the user previews a display effect of the display element.

In a possible implementation, the display element may be placed near an origin of the world space, so that the UI camera photographs and previews the display element.

Schematically, as shown in FIG. 7, a display element 703 may be placed in the scene. When the UI camera 701 photographs the display element 703, a display position of the display element may be presented in a photographing picture 704.

Operation 3: Adjust the element display position of the display element in the photographing picture when the display element is moved.

After the user views the display position of the display element by using a preview picture, if the display position of the display element needs to be adjusted, the user may change the position of the display element in the scene, and adjust the position of the display element according to the display effect in the photographing picture. Schematically, when the user needs to display the display element on the left side and the display element is currently displayed on the right side of the screen, the user may move the display element, and preview, according to the photographing picture, whether to move the display element to a required position.

When receiving a moving operation on the display element, the computer device may adjust the element display position of the display element in the photographing picture according to a moving position, so that the user performs a preview.

In some embodiments, the display element may be a particle effect. In a possible implementation, the user may create a virtual camera at an origin of the world space in a scene, and place a particle component that is set completely near the origin and within a photographing range of the camera. The particle component may be preset by using a Niagara system. A particle system is a method for modeling a fuzzy object to simulate some specific fuzzy objects, for example, objects having an abstract vision effect such as fire, explosion, fireworks, fallen leaves, and clouds. By using the Niagara system, the user may set a particle component for simulating a target object.

After the virtual camera photographs the particle component, the computer device may display a photographed particle effect, so that the user performs a preview and may adjust the display position according to an indication of the preview picture.

After the adjustment of the display position is completed, the material used for the display element may be adjusted. To be specific, the element offset function node is connected to the world position offset node, and the world position offset attribute is added to the display element.

In some embodiments, after the adjustment of the display position is completed, the created virtual camera may be deleted.

In a possible scene, the user may further need to display the display element in another scene, i.e. need to avoid blocking on the display element by another object in the scene. In this scene, the user may disable a depth test of the display element. Thus, in the rendering process, the depth test does not need to be performed on the display element, so that the display element is rendered on the scene picture.

Alternatively, in another possible implementation, a mode of disabling the depth test may be automatically performed by the computer device. To be specific, the computer device disables the depth test of the display element when the depth test corresponding to the display element is enabled, where the display element after the depth test is disabled is rendered onto the scene picture.

In some embodiments, the computer device may determine, according to a characteristic of the display element, whether to disable the depth test of the display element. In a possible implementation, when the computer device determines that the display element is a transparent object or a semitransparent object, the depth test of the display element may be automatically disabled. When the display element is a non-transparent object, the user may be prompted to determine whether to disable the depth test. When a user confirmation operation is received, the depth test of the display element is disabled.

Schematically, as shown in FIG. 8, a depth test 801 of the display element may be disabled (Disable Depth Test) on a setting interface.

In some embodiments, the display element may be a particle. There is a sprite particle in a particle model. The particle is a model based on a billboard technology, and keeps facing a scene camera during rendering, so that the particle on the screen rotates as a lens rotates during final rendering. When fixed rendering of the particle at a position on the screen needs to be implemented, facing of the Sprite particle needs to be set to a fixed facing, to avoid offset caused by rotation of the scene camera. The fixed facing may be a direction towards the UI camera.

To be specific, when detecting that the particle used by the particle model is the Sprite particle, the computer device may automatically set the facing thereof to a fixed facing. Certainly, the facing may further be set by the user. This is not limited in this embodiment.

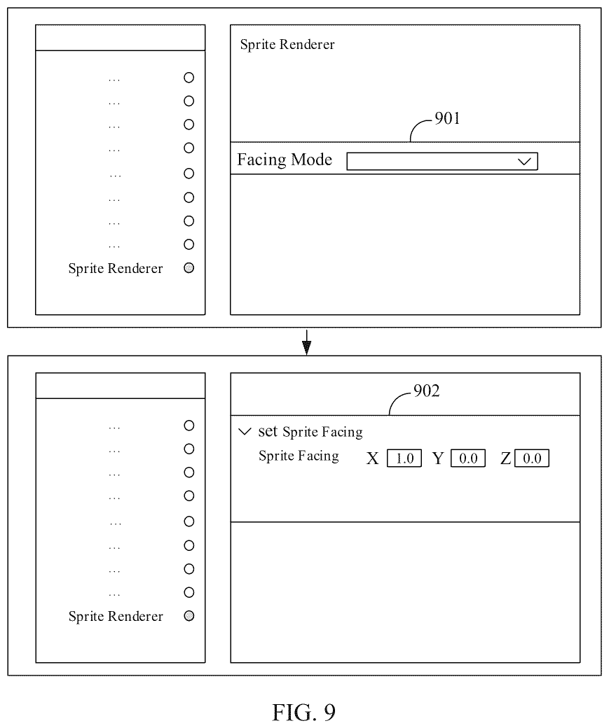

Schematically, as shown in FIG. 9, facing of a Sprite particle may be set in a sprite particle rendering interface (sprite renderer). A facing setting interface 902 may be triggered by a trigger operation on a facing setting control 901 (facing mode). The facing may be set to a fixed facing (1, 0, 0) in the facing setting interface 902.

In the method provided in embodiments of this application, only a rendering position of the display element on the screen is fixed, but an attribute of the display element is not changed. Schematically, when the particle effect is blooming off fireworks, the fireworks are always bloomed on a fixed position on the screen, and an original fireworks blooming attribute thereof is not affected.

In this embodiment, the display position of the display element is previewed by using the UI camera, so that the user may adjust the display position of the display element according to the preview picture, to complete user-defined setting of the display position. Thus, the display element may be rendered at a user-defined position in a subsequent rendering process.

In this embodiment, the depth test is disabled, so that the display element may be always displayed over another scene picture, thereby avoiding blocking on the display element.

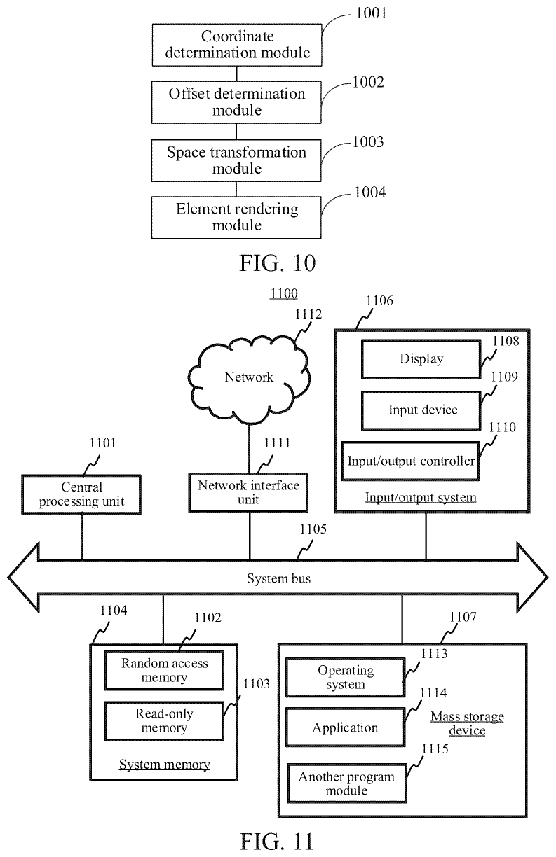

FIG. 10 is a structural block diagram of a display element rendering apparatus according to an exemplary embodiment of this application. As shown in FIG. 10, the apparatus includes:
a coordinate determination module 1001, configured to determine, based on vertex information of a display element, world vertex coordinates of the display element in a world space, where the display element is an element displayed at an unchanged position on a screen;
an offset determination module 1002, configured to determine a world position offset of the display element based on an offset mode of the world vertex coordinates in a view transformation process, where the world position offset is configured for canceling a relative offset of the world vertex coordinates in the view transformation process;
a space transformation module 1003, configured to perform coordinate space transformation based on the world vertex coordinates and the world position offset to obtain screen vertex coordinates of the display element in a screen space; and
an element rendering module 1004, configured to render the display element based on the screen vertex coordinates.

In some embodiments, the offset determination module 1002 is further configured to:
determine, based on an inverse vision matrix of a scene camera and a vision matrix of a UI camera, offset position coordinates of a vertex of the display element, where the scene camera is a camera corresponding to an observation view, and the UI camera is a camera located at an origin of the world space; and
determine a coordinate difference between the offset position coordinates and the world vertex coordinates as the world position offset.

In some embodiments, the offset determination module 1002 is further configured to:
transform the world vertex coordinates based on the vision matrix of the UI camera to obtain UI observation coordinates; and
transform the UI observation coordinates based on the inverse vision matrix of the scene camera to obtain the offset position coordinates.

In some embodiments, the offset determination module 1002 is further configured to:
perform coordinate axis transformation on the world vertex coordinates to obtain the UI observation coordinates; and
transform the UI observation coordinates based on a transformation mode from an observation space of the scene camera to the world space to obtain the offset position coordinates.

In some embodiments, the world vertex coordinates are provided by an absolute world position node in a material editor of a virtual engine.

In some embodiments, the coordinate axis transformation is implemented by editing a vector splitting node and a vector splicing node in the material editor.

In some embodiments, the transformation from the observation space to the world space is implemented by editing a coordinate transformation node in the material editor.

In some embodiments, the apparatus further includes:
a function encapsulation module, configured to perform encapsulation to obtain an element offset function node in response to a connection operation on the absolute world position node, the edited vector splitting node, the edited vector splicing node, and the edited coordinate transformation node, where the element offset function node is configured for invoking an element offset function, and the element offset function is configured for calculating the world position offset.

In some embodiments, the apparatus further includes:
an attribute addition module, configured to add, in response to a connection operation on the element offset function node and the world position offset node, a world position offset attribute to the display element, where the world position offset attribute is configured for indicating the element offset function.

Or,
the attribute addition module is further configured to connect the element offset function node to the world position offset node in response to an element fixing display instruction, and add a world position offset attribute to the display element, where the element fixing display instruction is configured for instructing to fix a display position of the display element on the screen.

In some embodiments, the apparatus further includes:
a camera creation module, configured to create a UI camera at an origin of coordinates in the world space in response to a camera creation instruction, where the UI camera is configured to photograph the display element;
an element display module, configured to present, when the UI camera photographs the display element within a scene, an element display position of the display element on the screen in a photographing picture of the UI camera; and
a position adjustment module, configured to adjust the element display position of the display element in the photographing picture when the display element is moved.

In some embodiments, the display element is a particle.

The apparatus further includes:
a facing setting module, configured to set, when an adopted particle model is a sprite particle, facing of the sprite particle to a fixed facing, where the fixed facing is a direction towards the UI camera.

In some embodiments, the apparatus further includes:
a test disabling module, configured to disable a depth test of the display element, where the display element after the depth test is disabled is rendered to an upper layer of a scene picture.

In some embodiments, the space transformation module 1003 is further configured to:
perform coordinate offset processing on the world vertex coordinates based on the world position offset to obtain updated world vertex coordinates; and
perform observation space transformation, clip space transformation, and screen space transformation on the updated world vertex coordinates to obtain the screen vertex coordinates.

In embodiments of this application, in a view transformation process, a computer device may determine a world position offset of a display element according to an offset of a world space that corresponds to the display element and is caused by view transformation. Thus, in a coordinate transformation process, the world position offset is introduced to cancel a position offset caused by the view transformation, so that screen vertex coordinates obtained after coordinate transformation remain unchanged. Even if a display position of the display element on a screen remains unchanged, a dynamic effect that the display element is moved with the view transformation is achieved. In this process, no additional module or plug-in needs to be used, and no additional storage space needs to be occupied. Continuous display of the display element is maintained in a mode of calculating the world position offset in real time, which is helpful to improve rendering efficiency.

The apparatus provided in the foregoing embodiments is illustrated only with an example of division of the foregoing function modules. In practical applications, the foregoing functions may be allocated to and completed by different function modules according to requirements. To be specific, the internal structure of the apparatus is divided into different function modules to complete all or some of the functions described above. In addition, the apparatus and method embodiments provided in the foregoing embodiments belong to the same conception. For an implementation process, refer to the method embodiments, and details are not described herein again.

FIG. 11 is a schematic structural diagram of a computer device according to an exemplary embodiment of this application. Specifically, the computer device 1100 includes a CPU 1101, a system memory 1104 including a random access memory (RAM) 1102 and a read-only memory (ROM) 1103, and a system bus 1105 connecting the system memory 1104 and the CPU 1101. The computer device 1100 further includes a basic input/output (I/O) system 1106 that facilitates transfer of information between elements within a computer, and a mass storage device 1107 that stores an operating system 1113, an application 1114, and another program module 1115.

In some embodiments, the basic I/O system 1106 includes a display 1108 configured to display information, and an input device 1109 configured to input information by a user, such as a mouse and a keyboard. The display 1108 and the input device 1109 are both connected to the CPU 1101 by using an I/O controller 1110 connected to the system bus 1105. The basic I/O system 1106 may further include the I/O controller 1110 to be configured to receive and process inputs from a plurality of other devices such as a keyboard, a mouse, and an electronic stylus. Similarly, the I/O controller 1110 further provides an output to a display screen, a printer, or another type of output device.

The mass storage device 1107 is connected to the CPU 1101 through a mass storage controller (not shown) connected to the system bus 1105. The mass storage device 1107 and a computer-readable medium associated therewith provide non-volatile storage for the computer device 1100. In other words, the mass storage device 1107 may include a non-transitory computer-readable storage medium (not shown) such as a hard disk or a drive.

Without loss of generality, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a random access memory (RAM), a read-only memory (ROM), a flash memory or another solid-state storage technology, a compact disc read-only Memory (CD-ROM), a digital versatile disc (DVD) or another optical memory, a magnetic cassette, a magnetic tape, a magnetic disk memory, or another magnetic storage device. Certainly, a person skilled in the art may learn that the computer storage medium is not limited to the foregoing several types. The system memory 1104 and the mass storage device 1107 may be collectively referred to as a memory.

The memory stores one or more programs. The one or more programs are configured to be executed by one or more CPUs 1101. The one or more programs include instructions for implementing the foregoing method. The CPU 1101 executes the one or more programs to implement the method provided in the foregoing various method embodiments.

According to embodiments of this application, the computer device 1100 may further be connected, via a network such as the Internet, to a remote computer on the network and run. In other words, the computer device 1100 may be connected to a network 1112 via a network interface unit 1111 connected to the system bus 1105, or may be connected to another type of network or a remote computer system (not shown) via a network interface unit 1111.

The memory further includes one or more programs, where the one or more programs are stored in the memory, and include operations that are configured for performing the method provided in the embodiments of this application and that are performed by the computer device.

Embodiments of this application further provide a non-transitory computer-readable storage medium. The non-transitory computer-readable storage medium has at least one computer instruction stored therein. The at least one computer instruction is loaded and executed by a processor to implement the display element rendering method provided in any of the foregoing embodiments.

Embodiments of this application provide a computer program product or computer program. The computer program product or computer program includes computer instructions. The computer instructions are stored in a non-transitory computer-readable storage medium. A processor of a computer device reads the computer instructions from the non-transitory computer-readable storage medium, and the processor executes the computer instructions to cause the computer device to perform the display element rendering method provided in the foregoing aspect.

A person of ordinary skill in the art may understand that all or some of the operations of the methods in the foregoing embodiments may be implemented by a program instructing relevant hardware. The program may be stored in a non-transitory computer-readable storage medium. The non-transitory computer-readable storage medium may be the non-transitory computer-readable storage medium included in the memory in the foregoing embodiment, or may be a non-transitory computer-readable storage medium that exists independently and that is not assembled in a terminal. The non-transitory computer-readable storage medium has at least one computer instruction stored therein. The at least one computer instruction is loaded and executed by a processor to implement the display element rendering method provided in any of the foregoing method embodiments.

In some embodiments, the non-transitory computer-readable storage medium may include: a ROM, a RAM, a solid state drive (SSD), an optical disc, or the like. The RAM may include a resistance random access memory (ReRAM) and a dynamic random access memory (DRAM). The sequence numbers of the foregoing embodiments of this application are merely for description purpose but do not imply the preference among the embodiments.

A person of ordinary skill in the art may understand that all or some of the operations of the foregoing embodiments may be implemented by hardware, or may be implemented by a program instructing relevant hardware. The program may be stored in a non-transitory computer-readable storage medium. The storage medium may be a ROM, a magnetic disk, an optical disc, or the like.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for rendering a display element performed by a computer device, the method comprising:
determining world vertex coordinates of the display element in a world space, the display element being an element displayed at an unchanged position on a screen;
determining a world position offset of the display element based on an offset mode of the world vertex coordinates in a view transformation process;
performing coordinate space transformation based on the world vertex coordinates and the world position offset to obtain screen vertex coordinates of the display element in a screen space; and
rendering the display element based on the screen vertex coordinates.

2. The method according to claim 1, wherein the determining a world position offset of the display element based on an offset mode of the world vertex coordinates in a view transformation process comprises:
determining, based on an inverse vision matrix of a scene camera and a vision matrix of a user interface (UI) camera, offset position coordinates of a vertex of the display element, the scene camera being a camera corresponding to an observation view, and the UI camera is a camera located at an origin of the world space; and
determining a coordinate difference between the offset position coordinates and the world vertex coordinates as the world position offset.

3. The method according to claim 2, wherein the determining, based on an inverse vision matrix of a scene camera and a vision matrix of a UI camera, offset position coordinates of a vertex of the display element comprises:
transforming the world vertex coordinates based on the vision matrix of the UI camera to obtain UI observation coordinates; and
transforming the UI observation coordinates based on the inverse vision matrix of the scene camera to obtain the offset position coordinates.

4. The method according to claim 3, wherein the transforming the world vertex coordinates based on the vision matrix of the UI camera to obtain UI observation coordinates comprises:
performing coordinate axis transformation on the world vertex coordinates to obtain the UI observation coordinates; and
the transforming the UI observation coordinates based on the inverse vision matrix of the scene camera to obtain the offset position coordinates comprises:
transforming the UI observation coordinates based on a transformation mode from an observation space of the scene camera to the world space to obtain the offset position coordinates.

5. The method according to claim 1, further comprising:
creating a UI camera at an origin of coordinates in the world space in response to a camera creation instruction, the UI camera being configured to photograph the display element;
presenting, when the UI camera photographs the display element within a scene, an element display position of the display element on the screen in a photographing picture of the UI camera; and
adjusting the element display position of the display element in the photographing picture when the display element is moved.

6. The method according to claim 5, wherein the display element is a particle,
the method further comprising:
setting, when an adopted particle model is a sprite particle, facing of the sprite particle to a fixed facing, the fixed facing being a direction towards the UI camera.

7. The method according to claim 1, further comprising:
disabling a depth test of the display element; and
after the depth test is disabled, rendering the display element to an upper layer of a scene picture.

8. The method according to claim 1, wherein the performing coordinate space transformation based on the world vertex coordinates and the world position offset to obtain screen vertex coordinates of the display element in a screen space comprises:
performing coordinate offset processing on the world vertex coordinates based on the world position offset to obtain updated world vertex coordinates; and
performing observation space transformation, clip space transformation, and screen space transformation on the updated world vertex coordinates to obtain the screen vertex coordinates.

9. A computer device, comprising a processor and a memory, the memory having at least one computer instruction stored therein, the at least one computer instruction being loaded and executed by the processor to implement a method for rendering a display element including:
determining world vertex coordinates of the display element in a world space, the display element being an element displayed at an unchanged position on a screen;
determining a world position offset of the display element based on an offset mode of the world vertex coordinates in a view transformation process;
performing coordinate space transformation based on the world vertex coordinates and the world position offset to obtain screen vertex coordinates of the display element in a screen space; and
rendering the display element based on the screen vertex coordinates.

10. The computer device according to claim 9, wherein the determining a world position offset of the display element based on an offset mode of the world vertex coordinates in a view transformation process comprises:
determining, based on an inverse vision matrix of a scene camera and a vision matrix of a user interface (UI) camera, offset position coordinates of a vertex of the display element, the scene camera being a camera corresponding to an observation view, and the UI camera is a camera located at an origin of the world space; and
determining a coordinate difference between the offset position coordinates and the world vertex coordinates as the world position offset.

11. The computer device according to claim 10, wherein the determining, based on an inverse vision matrix of a scene camera and a vision matrix of a UI camera, offset position coordinates of a vertex of the display element comprises:
transforming the world vertex coordinates based on the vision matrix of the UI camera to obtain UI observation coordinates; and
transforming the UI observation coordinates based on the inverse vision matrix of the scene camera to obtain the offset position coordinates.

12. The computer device according to claim 11, wherein the transforming the world vertex coordinates based on the vision matrix of the UI camera to obtain UI observation coordinates comprises:
performing coordinate axis transformation on the world vertex coordinates to obtain the UI observation coordinates; and
the transforming the UI observation coordinates based on the inverse vision matrix of the scene camera to obtain the offset position coordinates comprises:
transforming the UI observation coordinates based on a transformation mode from an observation space of the scene camera to the world space to obtain the offset position coordinates.

13. The computer device according to claim 9, wherein the method further comprises:
creating a UI camera at an origin of coordinates in the world space in response to a camera creation instruction, the UI camera being configured to photograph the display element;
presenting, when the UI camera photographs the display element within a scene, an element display position of the display element on the screen in a photographing picture of the UI camera; and
adjusting the element display position of the display element in the photographing picture when the display element is moved.

14. The computer device according to claim 13, wherein the display element is a particle,
the method further comprising:
setting, when an adopted particle model is a sprite particle, facing of the sprite particle to a fixed facing, the fixed facing being a direction towards the UI camera.

15. The computer device according to claim 9, wherein the method further comprises:
disabling a depth test of the display element; and
after the depth test is disabled, rendering the display element to an upper layer of a scene picture.

16. The computer device according to claim 9, wherein the performing coordinate space transformation based on the world vertex coordinates and the world position offset to obtain screen vertex coordinates of the display element in a screen space comprises:
performing coordinate offset processing on the world vertex coordinates based on the world position offset to obtain updated world vertex coordinates; and
performing observation space transformation, clip space transformation, and screen space transformation on the updated world vertex coordinates to obtain the screen vertex coordinates.

17. A non-transitory computer-readable storage medium, having at least one computer instruction stored therein, the at least one computer instruction being loaded and executed by a processor of a computer device to implement a method for rendering a display element rendering including:
determining world vertex coordinates of the display element in a world space, the display element being an element displayed at an unchanged position on a screen;
determining a world position offset of the display element based on an offset mode of the world vertex coordinates in a view transformation process;
performing coordinate space transformation based on the world vertex coordinates and the world position offset to obtain screen vertex coordinates of the display element in a screen space; and
rendering the display element based on the screen vertex coordinates.

18. The non-transitory computer-readable storage medium according to claim 17, wherein the determining a world position offset of the display element based on an offset mode of the world vertex coordinates in a view transformation process comprises:
determining, based on an inverse vision matrix of a scene camera and a vision matrix of a user interface (UI) camera, offset position coordinates of a vertex of the display element, the scene camera being a camera corresponding to an observation view, and the UI camera is a camera located at an origin of the world space; and
determining a coordinate difference between the offset position coordinates and the world vertex coordinates as the world position offset.

19. The non-transitory computer-readable storage medium according to claim 17, wherein the method further comprises:
creating a UI camera at an origin of coordinates in the world space in response to a camera creation instruction, the UI camera being configured to photograph the display element;
presenting, when the UI camera photographs the display element within a scene, an element display position of the display element on the screen in a photographing picture of the UI camera; and
adjusting the element display position of the display element in the photographing picture when the display element is moved.

20. The non-transitory computer-readable storage medium according to claim 17, wherein the performing coordinate space transformation based on the world vertex coordinates and the world position offset to obtain screen vertex coordinates of the display element in a screen space comprises:
performing coordinate offset processing on the world vertex coordinates based on the world position offset to obtain updated world vertex coordinates; and
performing observation space transformation, clip space transformation, and screen space transformation on the updated world vertex coordinates to obtain the screen vertex coordinates.
